(19) United States
(12) Patent Application Publication
(10) Pub. No.: US 2026/0229041 A1
(43) Pub. Date: Aug. 6, 2026

(54) Method for LiDAR Segmentation

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/457,126

(22) Filed: Jan. 22, 2026

Related U.S. Application Data
(60) Provisional application No. 63/753,934, filed on Feb. 4, 2025.
(60) Provisional application No. 63/774,871, filed on Mar. 20, 2025.

(51) Int. Cl. G06V 20/56; G01B 11/06; G01S 17/89; G01S 17/931; G05D 1/242; G05D 1/622; G06V 10/30; G06V 10/40; G06V 10/762; G06V 10/764

(52) U.S. Cl. CPC G06V 20/56; G01B 11/0608; G01S 17/89; G01S 17/931; G05D 1/242; G05D 1/622; G06V 10/30; G06V 10/40; G06V 10/762; G06V 10/764

(57) ABSTRACT

An autonomous work vehicle is disclosed that includes a Lidar sensor and a vehicle control unit in communication with the Lidar sensor. The vehicle control unit receives Lidar data comprising a point cloud including a plurality of points from the Lidar sensor; classify points from the point cloud into ground points and non-ground points, wherein the ground points represent the ground, and the non-ground points represent non-ground objects; estimate a height map based on the classified ground points; determine object features based on the non-ground points, the object features including at least one of a size of an object, a height of the object, a lowest point of the object, and a slope of a terrain under an object based on the classified ground and non-ground points and the estimated height map; classify the object as a hazard or non-hazard based on the determined object features.

### BACKGROUND

Autonomous work vehicle use a number of techniques for detecting potential obstacles. In some cases LiDAR data can be used for obstacle detection, which can have some inherent problems.

### SUMMARY

In some embodiments, an autonomous work vehicle may include a Lidar sensor and a vehicle control unit in communication with the Lidar sensor. The vehicle control unit may be configured to receive Lidar data comprising a point cloud including a plurality of points from the Lidar sensor. The vehicle control unit may classify points from the point cloud into ground points and non-ground points. The ground points may be considered to represent the ground, and the non-ground points may be considered to represent non-ground objects. The vehicle control unit may estimate a height map based on the classified ground points. The vehicle control unit may determine object features based on the non-ground points. The object features may include at least one of a size of an object, a height of the object, a lowest point of the object, and a slope of a terrain under an object based on the classified ground and non-ground points and the estimated height map. The vehicle control unit may classify the object as a hazard or non-hazard based on the determined object features. The vehicle control unit may be configured to send a limit signal to limit movement of the autonomous work vehicle if the object is classified as a hazard. The vehicle control unit may be configured to ignore the object if the object is classified as a non-hazard.

In some embodiments, methods may include receiving Lidar data comprising a point cloud including a plurality of points from a Lidar sensor on an autonomous work vehicle. The methods may include classifying points from the point cloud into ground points and non-ground points. The methods may include estimating a height map based on the classified ground points. The methods may include determining object features based on the non-ground points. The methods may include classifying the object as a hazard or non-hazard based on the determined object features. If the object is classified as a hazard, a limit signal may be sent to limit the movement of the autonomous work vehicle. If the object is classified as a non-hazard, the object may be ignored.

### BRIEF DESCRIPTION OF THE FIGURES

FIG. 1 is a sideview of an example autonomous yard truck.

FIG. 2 is a sideview of an autonomous tractor.

FIG. 3 is an isometric view of an autonomous mower.

FIG. 4 illustrates a block diagram of an example autonomous work vehicle communication system of the present disclosure.

FIG. 5 is a flow chart showing steps of a process for controlling the autonomous work vehicle.

FIG. 6 is an illustration of outputs of the method of FIG. 5.

FIG. 7 is a flow chart showing steps of a sub-process to FIG. 5, for determining object features.

FIG. 8 is a flow chart showing steps of a sub-process to FIG. 5, for determining whether to classify an object as a hazard.

FIG. 9 is a flow chart showing steps of a sub-process to FIG. 5, for determining whether to classify Lidar points as ground or non-ground points.

FIG. 10 is a block diagram of an example computational system (or controller).

### DETAILED DESCRIPTION

The following detailed description may be read with reference to the figures, in which like elements in different figures may be identically numbered. The figures may not be drawn to scale and may depict selected embodiments and may not depict every possible implementation. The detailed description illustrates by way of example, not by way of limitation, the principles of the disclosure. This description may enable one skilled in the art to make and use the disclosure, and the description may describe several embodiments, adaptations, variations, alternatives, and uses of the disclosure, including what may be presently believed to be the best mode of carrying out the disclosure.

Autonomous work vehicles may be increasingly used to perform useful work within operating environments. Such vehicles may rely on exteroceptive sensors such as cameras, LiDAR, and radar to perceive their surroundings and navigate safely. Despite advances in sensor technology and processing algorithms, further improvements may be needed to enhance the ability of autonomous work vehicles to detect and classify objects in their environment, particularly to distinguish between hazardous and non-hazardous objects. Accurate terrain mapping and object detection may be important for safe autonomous operation, especially in unstructured environments where the vehicle may encounter a wide variety of objects and terrain features.

Disclosed are systems and methods for processing sensor data to detect objects, classify terrain, and assess hazards in an operating environment of an autonomous work vehicle. The systems and methods may receive data from one or more sensors, such as LiDAR sensors, and may process the data to distinguish between ground points and non-ground points. The processed data may be used to generate a terrain map and to identify objects in the environment. The systems and methods may further classify detected objects based on their characteristics and may determine whether each object may pose a hazard to the vehicle. Based on the hazard assessment, the systems and methods may generate control signals to adjust vehicle operation, such as by limiting vehicle speed or altering the vehicle's path.

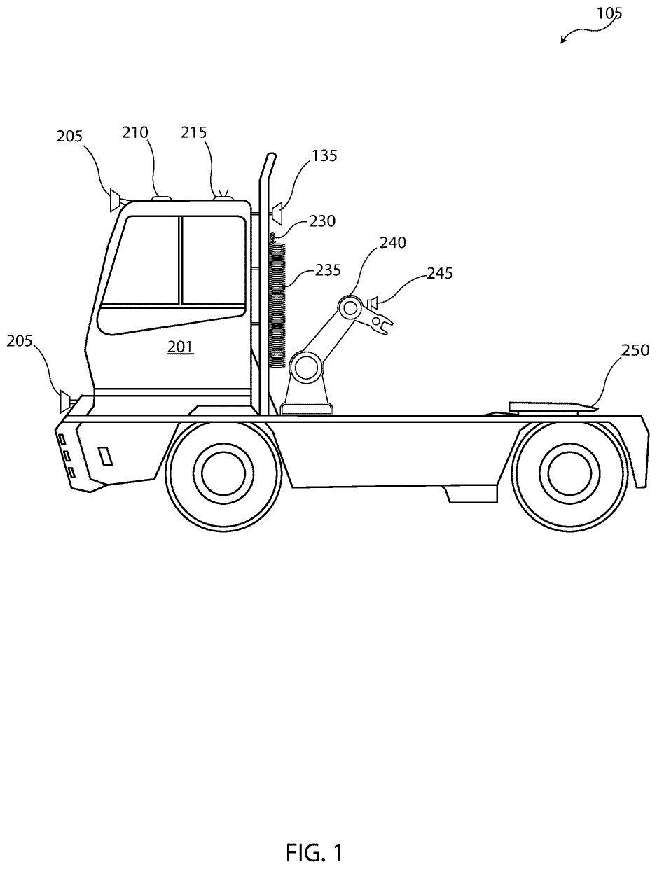

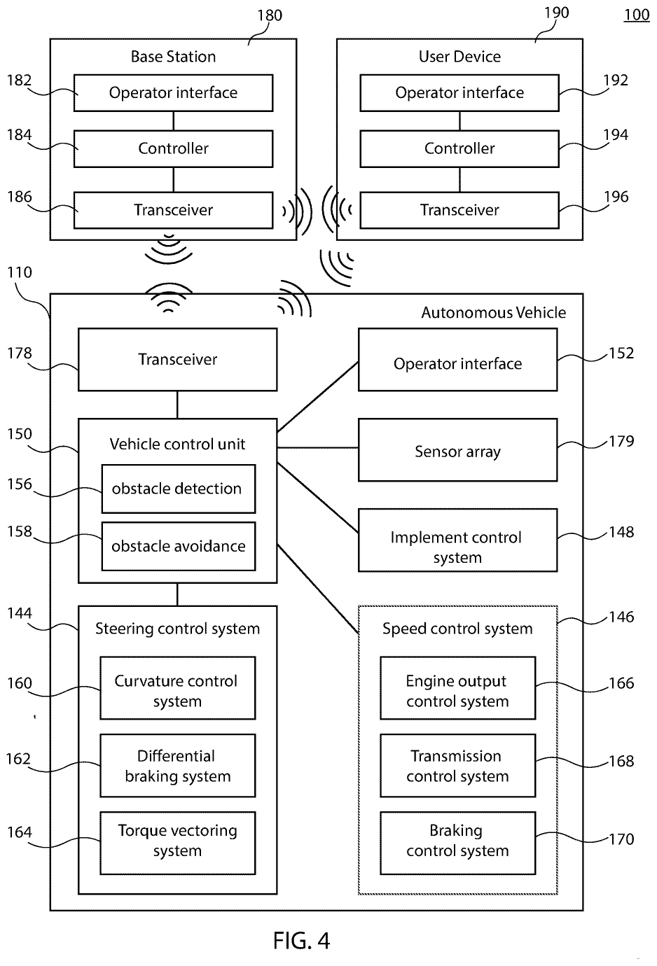

FIG. 1 shows an autonomous yard truck 105 which may be any type of autonomous yard truck. The autonomous yard truck 105 includes a cab 201 that may be used to drive the autonomous yard truck 105 manually. The autonomous yard truck 105 may include one or more controllers as described with reference to FIG. 4. The autonomous yard truck 105 may also include a brake system, an engine, a transmission, steering, etc.

In some embodiments, the autonomous yard truck 105 may include a sensor array that includes sensors 205 disposed at various locations on the autonomous yard truck 105 such as, for example, on the cab 201, bumper, housing, frame, etc. The sensors 205 may include infrared sensors, ultrasonic sensors, magnetic sensors, radar sensors, Lidar sensors, terahertz sensors, sonar sensors, a camera system including one or more cameras, etc. The cameras may be arranged to be front-facing to provide visual data of the front and/or front sides of the autonomous yard truck 105, rear-facing to provide visual data of the rear and/or rear sides of the autonomous yard truck 105, and/or internally within the cab 201 to provide visual data of an operator seat within the cab 201. The cameras of the camera system, for example, may comprise a fish-eye lens to capture a wider field of view. The cameras of the camera system, for example, may comprise an electro-optical camera, a stereo camera, a depth camera, an infrared camera, a neuromorphic camera, and/or a hyperspectral camera.

In some embodiments, the autonomous yard truck 105 may include a spatial locating device (or GPS) antenna 410. In some embodiments, the autonomous yard truck 105 may include a transceiver antenna 215.

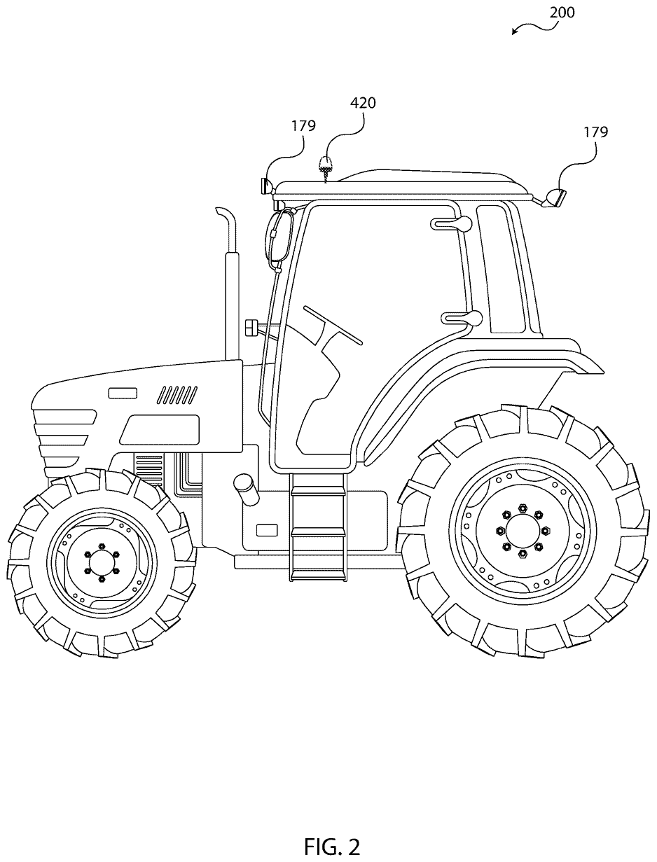

FIG. 2 is a sideview of an example autonomous tractor 200, which may include all or some of the components of autonomous work vehicle 110. In this example, the autonomous tractor 200 may include standard tractor equipment and/or components. The autonomous tractor 200 may include or be coupled with any kind of implement such as, for example, plow, disc plow, reel mower, dumper, lift, bucket, shovel, blade, cutter, etc. The autonomous tractor 200, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

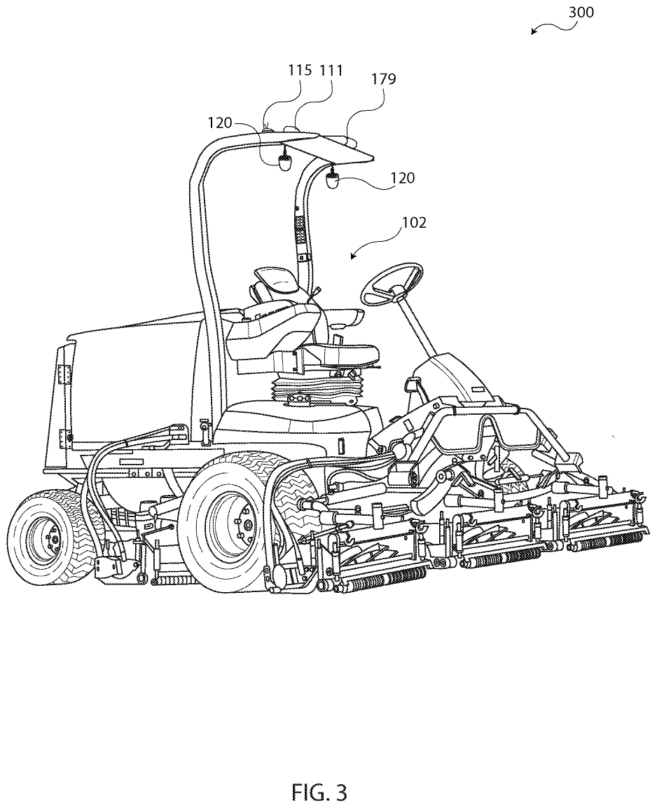

FIG. 3 is a sideview of an example autonomous mower 300. In this example, the autonomous mower 300 includes a disc mower. Any type of mower or blades may be used instead of the disc mower. The autonomous mower 300 may include an operator seat 102 or cab that may be used to drive the autonomous mower 300 manually. The autonomous mower 300 may include one or more controllers as described with reference to FIG. 4 below. The autonomous mower 300 may also include a brake system, an engine, a transmission, steering, etc.

In some embodiments, the autonomous mower 300, may include a sensor array 179 (or multiple sensor arrays) including sensors disposed at various locations on the autonomous mower 300 such as, for example, on the operator seat 102, on the frame, housing etc. The sensor array 179 may include one or more Lidar sensors 120. The Lidar sensors 120 may provide Lidar data comprising a point cloud including a plurality of points corresponding to objects and surfaces which reflect laser pulses from the Lidar sensors 120. In some examples, the sensor array 179 may also include other sensors, for example, infrared sensors, ultrasonic sensors, magnetic sensors, radar sensors, terahertz sensors, sonar sensors, a camera system including one or more cameras, etc.

In some embodiments, the autonomous mower 300 may include a spatial locating device (or GPS) 111. In some embodiments, the autonomous mower 300 may include a transceiver antenna 115.

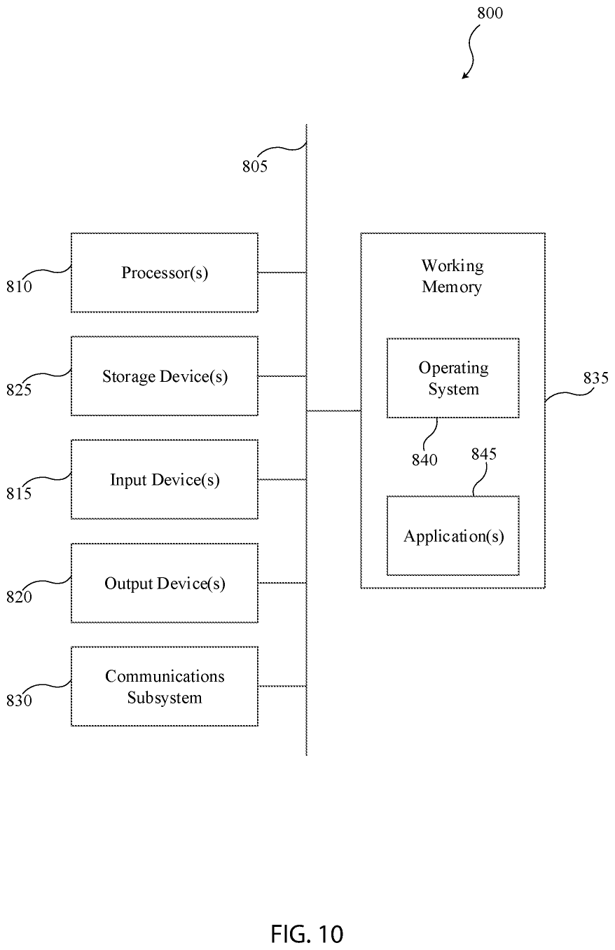

FIG. 4 is a block diagram of a communication and control system 100 that may be utilized in conjunction with the systems and methods of the disclosure. The communication and control system 100 may include a vehicle control unit 150 which may be mounted on an autonomous work vehicle 110. The autonomous work vehicle 110, for example, may include the autonomous mower 300 of FIG. 1, a yard truck, loader, wheel loader, track loader, dump truck, digger, backhoe, forklift, etc. The communication and control system 100, for example, may include any or all components of computational unit 800 shown in FIG. 10.

For example, the autonomous work vehicle 110 may include a steering control system 144 that may control a direction of movement of the autonomous work vehicle 110. The steering control system 144, for example, may include any or all components of computational unit 800 shown in FIG. 10.

The autonomous work vehicle 110, for example, may include a speed control system 146 that controls the speed, acceleration, and deceleration of the autonomous work vehicle 110. The speed control system 146, for example, may control the speed of the autonomous work vehicle 110 based on map data, control algorithms, obstacle detection, start and/or stop points, input from the 174, etc. The speed control system 146, for example, may include any or all components of computational unit 800 shown in FIG. 10.

The autonomous work vehicle 110, for example, may include an implement control system 148 that may control operation of an implement towed the autonomous work vehicle 110 or integrated within the autonomous work vehicle 110 or coupled to the autonomous work vehicle 110. The implement control system 148 may, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a rotavator, a ditcher, a dozer blade, a backhoe, an excavator, a disc plow, a seeder, a fertilizer, etc. The implement control system 148, for example, may include any or all components of computational unit 800 shown in FIG. 10.

The autonomous work vehicle 110, for example, may include an obstacle detection system 156 which may detect obstacles around the vicinity of the autonomous work vehicle 110. The obstacle detection system 156 may detect obstacles using inputs from, for example, the sensor array 179. Additionally, or alternatively, an obstacle avoidance system 158 may use data from the obstacle detection system 156 to create one or more alternative paths around obstacles detected by the obstacle detection system 156.

In this example, the obstacle detection system 156 and the obstacle avoidance system 158 may be part of the vehicle control unit 150. Alternatively, either or both the obstacle detection system 156 and the obstacle avoidance system 158 may not be part of the vehicle control unit 150. The obstacle detection system 156 and/or the obstacle avoidance system 158 may comprise separate controllers that communicate with vehicle control unit 150 and/or the sensor array 179 and/or the steering control system 144 and/or speed control system 146.

The vehicle control unit 150 may be communicatively coupled with the steering control system 144, the speed control system 146, and the implement control system 148. The vehicle control unit 150, for example, may include any or all the components shown in FIG. 10. The vehicle control unit 150, for example, may be integrated into a single controller or may include a plurality of distinct components or controllers. The vehicle control unit 150 may also be coupled with one or more sensors from a sensor array 179 and receive sensor data from the sensor array 179.

The vehicle control unit 150, for example, may be used to control various aspects of the vehicle such as, for example, sending instructions to the steering control system 144, implement control system 148, speed control system 146, etc. The vehicle control unit 150, for example, may include a vehicle artificial intelligence (VAI) that may include one or more processors that execute one or more algorithms.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 179 or from base station 174.

The vehicle control unit 150, for example, may be an electronic controller with electrical circuitry configured to process data from the various components of the autonomous work vehicle 110. The vehicle control unit 150 may include any or all a processor, such as the processor 810, and a working memory 835. The vehicle control unit 150 may also include one or more storage devices and/or other suitable components of computational system 800. The processor 154 may be used to execute software, such as software for calculating drivable path plans. Moreover, the processor 154 may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors. The vehicle control unit 150, for example, may include any or all the components show in FIG. 10.

The vehicle control unit 150, for example, may include a volatile memory, such as random access memory (RAM), and/or a nonvolatile memory, such as ROM (e.g., working memory 835 and/or storage device 825). The memory may store a variety of information and may be used for various purposes. For example, the memory may store processor-executable instructions (e.g., firmware or software) for the vehicle control unit 150 to execute, such as instructions for calculating drivable path plan, and/or controlling the autonomous work vehicle 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

The steering control system 144, for example, may include a curvature rate control system 160, a differential braking system 162, a steering mechanism, and a torque vectoring system 164 that may be used to steer the autonomous work vehicle 110. The curvature rate control system 160, for example, may control a direction of an autonomous work vehicle 110 by controlling a steering control system of the autonomous work vehicle 110 with a curvature rate, such as an Ackerman style autonomous work vehicle, or articulating vehicle. The curvature rate control system 160, for example, may automatically rotate one or more wheels or tracks of the autonomous work vehicle 110 via hydraulic or electric actuators to steer the autonomous work vehicle 110. By way of example, the curvature rate control system 160 may rotate front wheels/tracks, rear wheels/tracks, and/or intermediate wheels/tracks of the autonomous work vehicle 110 or articulate the frame of the vehicle, either individually or in groups. The differential braking system 162 may independently vary the braking force on each lateral side of the autonomous work vehicle 110 to direct the autonomous work vehicle 110. Similarly, the torque vectoring system 164 may differentially apply torque from the engine to the wheels and/or tracks on each lateral side of the autonomous work vehicle 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous work vehicle 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous work vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous work vehicle 110. Furthermore, the braking control system 170 may adjust braking force to control the speed of the autonomous work vehicle 110. While the illustrated speed control system 146 includes the engine output control system 166, the transmission control system 168, and the braking control system 170, the speed control system 146 may include one or two of these systems. The speed control system 146, for example, may also include other systems and/or additional systems that may be used to control the speed of the autonomous work vehicle 110.

The implement control system 148, for example, may control various parameters of the implement towed by and/or integrated within the autonomous work vehicle 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement, which may reduce the draft load on the autonomous work vehicle 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The communication and control system 100, for example, may include a sensor array 179. The sensor array 179, for example, may facilitate determination of condition(s) of the autonomous work vehicle 110 and/or the work area. For example, the sensor array 179 may include one or more Lidar sensors 120 with a field of view around the autonomous work vehicle 110 (such as shown on the autonomous mower 300 of FIG. 1). The Lidar sensors 120 and/or other sensors of the sensor array 179, for example, may detect physical objects in the work area, such as a parking stall, a material stall, accessories, other vehicles, obstacles, environmental features, or other object(s), such as people, that may in the area surrounding the autonomous work vehicle 110. The sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor a rotation rate of a respective wheel or track and/or a ground speed of the autonomous work vehicle 110. The sensors may also monitor operating levels (e.g., temperature, fuel level, etc.) of the autonomous work vehicle 110. Furthermore, the sensors may monitor conditions in and around the work area, such as temperature, weather, wind speed, compass, humidity, and other conditions.

The sensor array 179, for example, may include a velocity sensor which may include one or more of an inertial measurement unit, a compass, a GPS sensor, a wheel encoder, a tachometer, a camera, a radar, etc. The sensor array 179, for example, may also include a steering angle sensor. The velocity sensor, for example, may produce velocity data. Velocity data may include speed and/or bearing. Velocity data, for example, may also include steering angular rate.

The operator interface 152, for example, may be communicatively coupled to the vehicle control unit 150 and configured to present data from the autonomous work vehicle 110 via a display. Display data may include data associated with operation of the autonomous work vehicle 110, data associated with operation of an implement, detected objects, whether any detected objects are considered hazards, a position of the autonomous work vehicle 110, a speed of the autonomous work vehicle 110, a desired path, a drivable path plan, a target position, a current position, etc. The operator interface 152 may enable an operator to control certain functions of the autonomous work vehicle 110 such as starting and stopping the autonomous work vehicle 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that a speed of the autonomous work vehicle 110 remain within certain limits, that a lateral acceleration experienced by the autonomous work vehicle 110 remain within certain limits, etc. In addition, the operator interface 152 (e.g., via the display, or via an audio system (not shown), etc.) may alert an operator if the desired path cannot be achieved, for example.

The vehicle control unit 150, for example, may include a base station 174 having a base station controller 176 located remotely from the autonomous work vehicle 110. For example, the control functions of the vehicle control unit 150 may be distributed between the vehicle control unit 150 of the autonomous work vehicle control unit 150 and the base station controller 176. The base station controller 176, for example, may perform a substantial portion of the control functions of the vehicle control unit 150. For example, a first transceiver 178 positioned on the autonomous work vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 180 at the base station 174. The base station controller 176, for example, may calculate drivable path plans and/or output control signals to control the curvature rate control system 160, the speed control system 146, and/or the implement control system 148 to direct the autonomous work vehicle 110 toward the desired path, for example. The base station controller 176 may include a processor and memory device having similar features and/or capabilities as the processor and the memory device discussed previously. Likewise, the base station 174 may include an operator interface 186 having a display, which may have similar features and/or capabilities as the operator interface 152 and the display discussed previously.

In some embodiments, the base station 174 and/or the autonomous work vehicle 110 may be in communication with a user device. A user device my include a phone, tablet, laptop, or computer. The user device, for example, can include an application that allows the user to communicate commands to the autonomous work vehicle 110 and/or receive information about the autonomous work vehicle 110. Alternatively or additionally, the user device, for example, can include an application that allows the user to observe the autonomous work vehicle 110 move through a map of the work area where the autonomous work vehicle operates.

The user device, for example, may include an application that can receive any of the user inputs disclosed in this document. The user device, for example, may include an application that can display any of the information disclosed in this document.

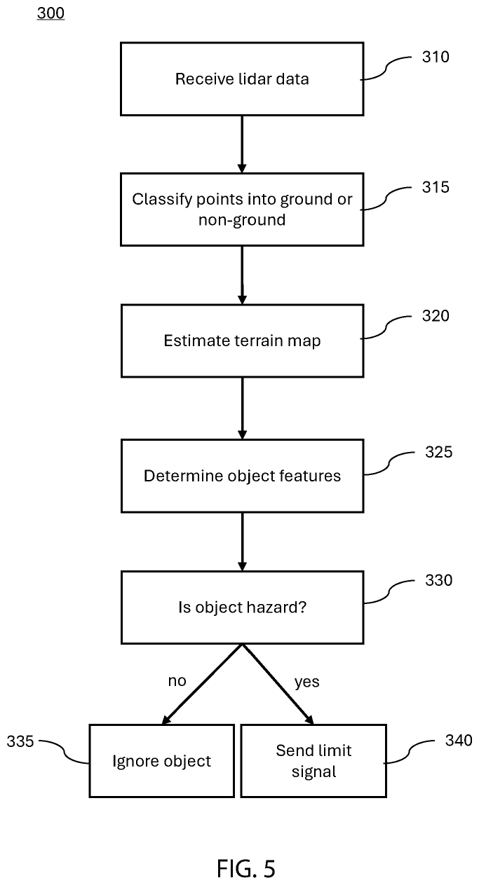

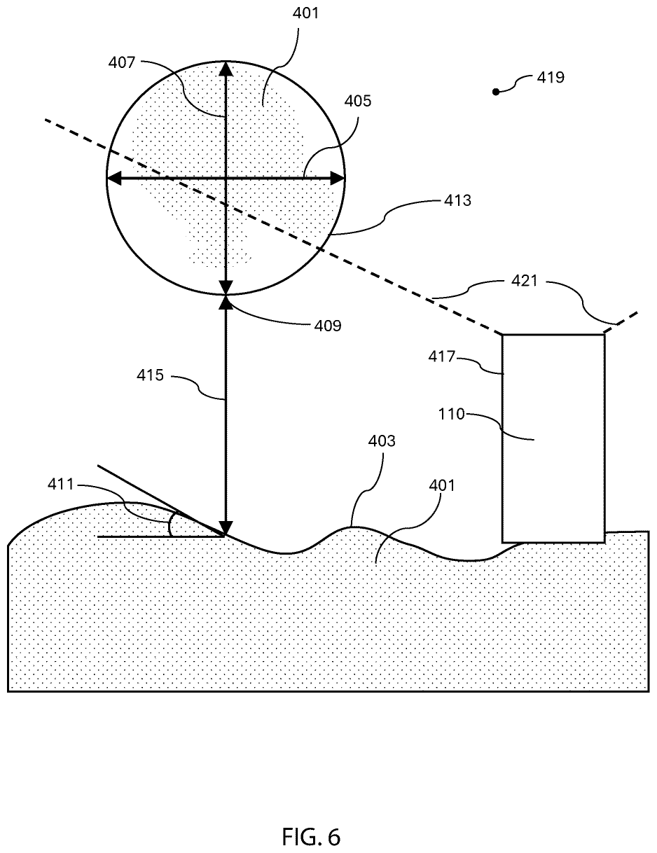

FIG. 5 is a flow chart of an example process 300 for controlling the autonomous work vehicle 110 with an obstacle detection algorithm. Process 300 may be executed in part by, for example, the obstacle detection system 156. FIG. 6 shows an example output from the obstacle detection system 156 which may be executing process 300 as well as subprocesses 500, 600 and 700 described with reference to FIGS. 5-7. The output in FIG. 6 represents the output of the Lidar viewed from the side.

Process 300 starts at block 310. At block 310, the obstacle detection system 156 may receive Lidar data from the Lidar sensors 120. The Lidar data may comprise a point cloud 401 (shown in FIG. 6) including a plurality of points. The plurality of points may correspond to objects or surfaces in the vicinity of the autonomous work vehicle 110 from which lasers sent by the Lidar sensors 120 are reflected back to the Lidar sensors.

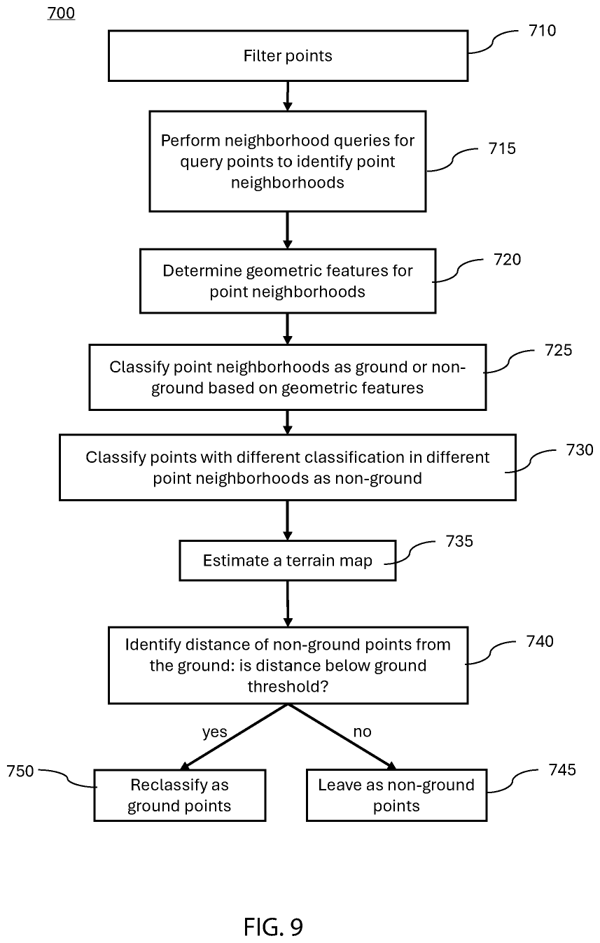

At block 315, the obstacle detection system 156 may classify the points in the point cloud 401 into ground points, representing ground or terrain around the autonomous work vehicle 110 within the field of view of the Lidar sensors 120, and non-ground points, representing non-ground objects within the field of view of the Lidar sensors. An example process 700 for classifying the points into ground points and non-ground points is set out in more detail with reference to FIG. 9.

At block 320, the obstacle detection system 156 may estimate a terrain map 403 based on the classified ground points. The terrain map 403 may represent the terrain around the autonomous work vehicle 110. The terrain map 403 may be estimated by generating a height map including a 2D matrix (in other words a plane as viewed from above the autonomous work vehicle 110) wherein each cell may be populated with the height of corresponding points classified as ground points in block 315. For each cell in the 2D matrix, the height map may be populated with the lowest ground point identified in that cell. Where there are non-observed cells in the height map (i.e., there are no ground points in the point cloud 401 in a particular cell in the 2D map), the height of the non-observed cells may be interpolated from observed points. The interpolation of non-observed points may be performed using inverse-distance weighting of the K nearest neighbor (KNN) cells, for example, including forming a K-D tree of the observed cells. Performing KNN lookup in a small K-D Tree is more efficient and faster compared to iterating over the entire heightmap.

Using the height map with both the observed and interpolated non-observed points, the terrain map 403 may be estimated. The terrain map may be estimated, for example, by fitting a 3D plane for each cell to the height map points within an extended Moore neighborhood of each cell. A design matrix for the 3D plane in each extended Moore neighborhood may be computed using a least-squares fit for points away from the edges. Other methods of best fit calculation for the 3D plane may also be used. The 3D plane and slopes of the 3D plane may be stored in a memory. In some examples, block 320 may only estimate the height map, instead of the terrain map 403 (i.e., may not calculate a best fit 3D plane to the height map to estimate the terrain map 403), but may simply join the points together to calculate local slopes and positions of the ground. In further examples, the terrain map may be estimated based only on the observed points, without interpolating the non-observed points.

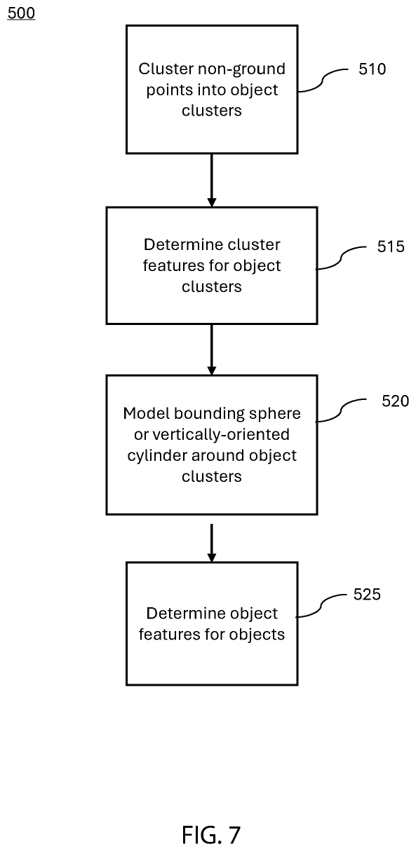

At block 325, the obstacle detection system 156 may determine object features including, for example, a size of an object 405, a height of the object 407, a lowest point of the object 409, and a slope 411 of the terrain under the object. The object features may be determined based on classified non-ground points, and in the case of the slope 411 of the terrain may also be determined based on ground points and the estimated height map or terrain map 403. An example process 500 for determining object features is set out in more detail in FIG. 7.

Referring to the example process 500 for determining objects features with reference to FIG. 7, at block 510, the obstacle detection system 156 may cluster non-ground points into object clusters representing objects in the vicinity of the autonomous work vehicle 110. This clustering may be performed, for example, using a Rusu's Euclidean Clustering algorithm, Fast Euclidean Clustering algorithm, or any suitable algorithm. A K-D tree of non-ground points may be formed to do the clustering. To accommodate decreased point density at longer ranges, a clustering radius or threshold may be adjusted based on the range of the cluster query point.

At block 515, the obstacle detection system 156 may determine cluster features for the object clusters including, for example, number of points in the object cluster, a height of the lowest point of the object cluster above the ground based on the height map, a height difference between the highest point and the lowest point of the object cluster, and/or average last return ratio of the points in the object cluster. The last return ratio may be a ratio which represents how far a point is along a laser that has had multiple returns (i.e., echoes). For example, where a laser hits a first object and partially reflects, but continues and hits a second object and fully reflects, the point at the first object has a last return ratio of ½, whereas the point at the second object has a last return ratio of 1. The last return ratios of a cluster of points can therefore be averaged to determine an average last return ratio. The average last return ratio may give an indication of the porosity of the object represented by the object cluster.

At block 520, the obstacle detection system 156 may model a bounding sphere 413 (shown in FIG. 6) or a vertically oriented cylinder (not shown) around an object cluster. The bounding sphere 413 or vertically oriented cylinder may be modelled in such a way as to ensure that every point in the object cluster is bounded by the edges of the bounding sphere 413 or vertically oriented cylinder. In other examples, any suitable three-dimensional shape may be modelled around the object cluster.

At block 525, the obstacle detection system 156 may determine the object features based on the points within the object cluster and the modelled bounding sphere 413 or vertically oriented cylinder. For example, a size of the object may be determined to be the diameter 405 of the bounding sphere 413 or the vertically oriented cylinder, or may be considered to be any suitable dimension of the modelled shape around the object cluster. The lowest point of the object may be considered to be the lowest point of the modelled shape 409, and the height of the object may be considered to be the height 407 of the modelled shape. In some examples, block 520 may be omitted, and the object features may be the same as the cluster features.

Referring back to FIG. 5, at block 330, the obstacle detection system 156 may classify the object as a hazard or a non-hazard based on the determined object features in block 325. If the object is classified as a hazard, the process 300 may proceed to block 340, and if the object is classified as a non-hazard, the process 300 may proceed to block 335. References to classifying an object as a hazard may refer to the object itself presenting a hazard to the autonomous work vehicle 110, or may refer to the autonomous work vehicle 110 presenting a hazard to the object.

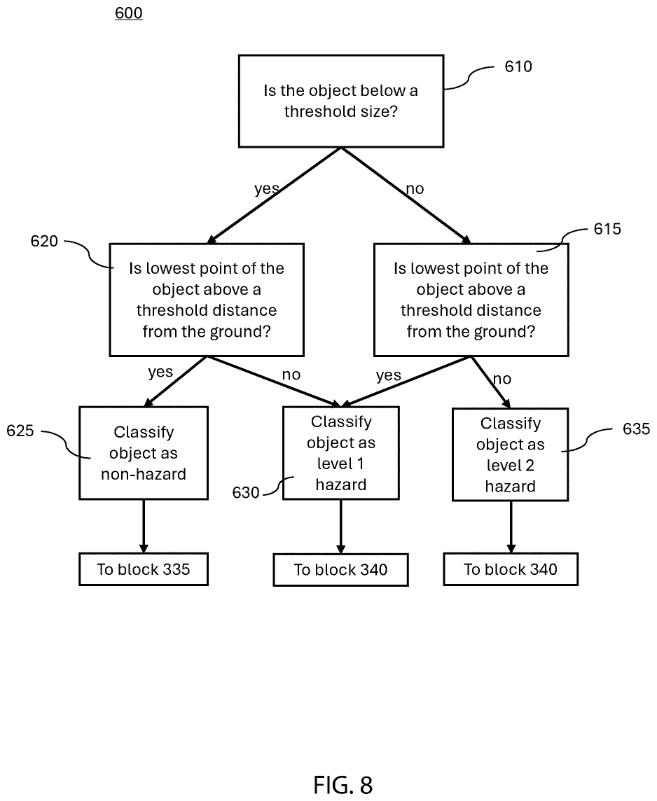

Some objects, such as people, which may be considered to be hazards (or to whom the autonomous work vehicle 110 would be considered a hazard), are usually on the ground and stationary, while other identified objects within the vicinity of an autonomous work vehicle 110, such as birds, may be airborne and may move quickly away from the vehicle such that they do not present a hazard to the autonomous work vehicle 110, and the autonomous work vehicle 110 does not present a hazard to them. Block 330 may help to distinguish between such objects so that those objects which are unlikely to require the autonomous work vehicle 110 to stop or evade them can be safely ignored. An example process 600 for determining whether the object is a hazard or non-hazard is described in more detail with reference to FIG. 8.

Referring to the example process 600 for determining whether an object is a hazard or non-hazard shown in FIG. 8, at block 610, the obstacle detection system 156 may determine whether the object is below a threshold size based on the determined object features in block 325 of process 300. For example, a threshold size may relate to the bounding sphere 413 or the vertically oriented cylinder modelled in block 520 of process 500 being 12 inches. The threshold size in some examples may be anywhere between 12 inches and 18 inches. In other examples, the threshold size may be any suitable size. If the object is below a threshold size, the process 600 may proceed to block 620. If the object is not below a threshold size, the process 600 may proceed to block 615.

At block 615, the obstacle detection system 156 may determine whether the distance from the ground 415 (shown in FIG. 6) of the lowest point of the object is above a threshold distance in a vertical direction. In other words, the obstacle detection system 156 may determine whether the object is hovering above the ground by at least a threshold distance. If the lowest point of the object is above a threshold distance from the ground, the process 600 may proceed to block 630. If the lowest point of the object is not above a threshold distance from the ground, the process 600 may proceed to block 635.

In block 635, the obstacle detection system 156 has determined that the object is large and, on the ground, and may therefore classify the object as a hazard. In this example, the obstacle detection system 156 may classify the object as a level 2 hazard, which may indicate that the object is likely to be human.

At block 630, the obstacle detection system 156 has determined that the object is large and hovering off the ground, and may therefore classify the object as a hazard. In this example, the obstacle detection system 156 may classify the object as a level 1 hazard, which may indicate that the object is not likely to be a human, but may still be a hazard.

At block 620, the obstacle detection system 156 may determine whether the distance from the ground 415 (shown in FIG. 6) of the lowest point of the object is above a threshold distance in a vertical direction in a similar manner to block 615. In other words, the obstacle detection system 156 may determine whether the object is hovering above the ground by at least a threshold distance. If the lowest point of the object is above a threshold distance from the ground, the process 600 may proceed to block 625. If the lowest point of the object is not above a threshold distance from the ground, the process 600 may proceed to block 630.

In block 625, the obstacle detection system 156 may classify the object as a non-hazard. In other words, when the object is smaller than a threshold size and it is hovering above the ground over a threshold distance (as, for example, a bird flying past the autonomous work vehicle would be), the object is classified as a non-hazard.

By reaching block 630 from block 620, the obstacle detection system 156 has determined that the object is small and, on the ground, which may represent a plant or small object which is unlikely to be a human.

Referring back to FIG. 5, at block 335, the object has been classified by the obstacle detection system 156 as a non-hazard, and the obstacle detection system 156 and the obstacle avoidance system 158 may therefore ignore the object.

At block 340, the object has been classified by the obstacle detection system 156 as a hazard, and so the obstacle detection system 156 may send a limit signal to, for example, the obstacle avoidance system 158, to limit movement of the autonomous work vehicle 110. Limiting movement of the autonomous work vehicle 110 may comprise stopping the autonomous work vehicle 110, or may comprise preventing the autonomous work vehicle 110 from entering an exclusion zone within a threshold gap from the object. The exclusion zone (i.e., the threshold gap) may be, for example, 1.1 m. In other words, the autonomous work vehicle 110 may be prevented from travelling within 1.1 m of the object identified as a hazard. The size of the exclusion zone may depend on the hazard classification. For example, the hazard classification of block 635 (i.e., the object may be a human) may result in an exclusion zone of 1.1 m, while the hazard classification of block 630 (i.e., the object is unlikely to be a human but may still present a small hazard) may result in a smaller exclusion zone, such as 0.8 m, 0.5 m, or 0.3 m. In other words, if the object is small and, on the ground, or if the object is large and hovering, then the exclusion zone may be made smaller than if the object is large and, on the ground, since the potential hazard presented by the object, or to the object by the autonomous work vehicle, may not be as severe.

In some examples, the exclusion zone (i.e., the threshold gap) may be dynamically determined based on a steepness of the terrain adjacent to or under the object. The steepness of the terrain may be estimated based on the height map or the terrain map 403 (which is also based on the height map). For example, the steeper the terrain, the smaller the threshold gap may be. It is more difficult to distinguish objects from ground on steep terrain such that dynamically determining the threshold gap reduces the likelihood of false obstacle triggers for small objects on steep slopes. As the autonomous work vehicle 110 approaches the small object on the steep slope, it may be able to distinguish the object more clearly. In some examples, the dynamic change may include step changes in the threshold gap for different ranges of steepness. In other examples, the threshold gap may be inversely proportional to the steepness. In other examples, any suitable relationship may be established between the threshold gap and the steepness of the terrain in the vicinity of the object.

In some examples, the steepness of the terrain may also change other thresholds for identification of hazards in process 600. For example, the threshold size in block 610 or threshold distance from the ground in blocks 615 and 620 may be bigger for steeper terrain.

FIG. 9 is a flow chart showing an example process 700 for classifying points into ground and non-ground in block 315 of process 300 described with reference to FIG. 5.

At block 710, the obstacle detection system 156 may filter points within the point cloud 401 (shown in FIG. 6). Filtering points may be based on, for example, attributes and/or on area checks and/or lonely points 419.

For example, lonely points 419, that is points which are far from any other points are likely to be outliers. Therefore, points which are identified as lonely points 419 may be filtered out, such that they are excluded from consideration by the obstacle detection system 156. A threshold for considering a point to be a lonely point may change as a function of range from the autonomous work vehicle 110, as for example, at close ranges to the autonomous work vehicle 110, the point density should be high, whereas at further ranges from the autonomous work vehicle 110, the point density may be more likely to be lower.

Other examples of filtering points may include attribute filtering. In attribute filtering, points with a low intensity (i.e., below a threshold intensity) may be filtered out, such that they are excluded from consideration by the obstacle detection system 156, as they are also more likely to be outliers. Other examples of attribute filtering include filtering for last return points, that is, for a given ray, taking only the last point for consideration, as any previous points which have allowed the ray to continue are not likely to have been reflected off a solid surface.

Area checks may also be used to filter points. For example, points which are identified as being within an envelope 417 bounding the autonomous work vehicle 110, such as points within a reference polygon which is known to represent the autonomous work vehicle 110, may be excluded from consideration by the obstacle detection system 156, as it is likely that any such points would represent the autonomous work vehicle 110 or its contents, and would therefore move with the autonomous work vehicle 110.

Other area checks may involve filtering by classifying points from the point cloud 401 as non-ground points when they are above a threshold plane 421 (shown in FIG. 6) from the vehicle. For example, a threshold plane 421 which is extending outward and upward in all directions from the autonomous work vehicle 110 may represent a volume around the autonomous work vehicle 110, above which, it is highly unlikely that there will be ground, even with steep changes in terrain, such that these points can be safely and easily classified as non-ground. These points would not be excluded from consideration by the obstacle detection system 156.

Information about points which have been filtered out, and thereby excluded from consideration by the obstacle detection system 156, may be retained in a memory, as they may still be useful in other operations.

At block 715, the obstacle detection system 156 may perform neighborhood queries for a plurality of query points. Each neighborhood query may identify point neighborhoods using a KD Tree, followed by the creation of a covariance matrix including computing the eigenvalues and eigenvectors. Point neighborhoods may be defined as a plurality of points within a query radius of a respective query point. Using an assumption that geometric features do not change rapidly over a small area, the query points may only include down-sampled points, such as by voxel-based down-sampling, in order to reduce the computation required. In such examples, a neighborhood query may be performed on one point within each voxel. In this example, the query radius for the neighborhood query may be larger than the voxel size, or may be larger than a value that scales with the voxel size to ensure that every observed point is considered within at least one point neighborhood.

At block 720, the obstacle detection system 156 may determine geometric features for each of the point neighborhoods. Geometric features which may be determined for each point neighborhood may include, for example, smoothness, eigenvalues of a structure tensor matrix, omnivariance, surface variation, sphericity, height difference and/or orientation. Geometric features may include any suitable features which can be derived from the point cloud.

At block 725, the obstacle detection system 156 may classify each of the point neighborhoods as ground or non-ground based on the respectively determined geometric features for each point neighborhood. Each geometric feature is classified as ground or non-ground using a classification technique such as Logistics Regression, Random Forest, or thresholds, and this may be used to determine whether the respective point neighborhood is ground or non-ground. This may involve a training model with labeled data. Each of the points within the point neighborhood is thereby classified as either ground or non-ground. For example, where a point neighborhood is classified as ground, each of the points within that point neighborhood are also classified as ground and where a point neighborhood is classified as non-ground, each of the points within that point neighborhood are classified as non-ground.

In some examples, the process 700 may end at block 725, with ground points and non-ground points classified for block 315 of process 300, such that a terrain map 403 may then be estimated with the ground points populating the height map in block 320 of process 300. In other examples, block 725 the process 700 may continue to block 730.

At block 730, if there are points in overlapping point neighborhoods, then they may be classified differently in each of the neighborhoods. In the event that a point is classified differently in two different point neighborhoods, the obstacle detection system 156 may give precedence to the non-ground classification, such that the point is classified as non-ground.

At block 735, the obstacle detection system 156 may include estimating the terrain map 403 or height map based on the determined ground points, in a similar manner to block 320 of process 300.

At block 740, the obstacle detection system 156 may identify the distance of each non-ground point from the ground, for example, against the estimated terrain map 403 or height map from block 735. If the distance from the ground 415 is determined to be below a ground threshold, the process 700 may proceed to block 750. If the distance from the ground 415 is determined not below the ground threshold (i.e., it is at or above the ground threshold), the process 700 may proceed to block 745.

At block 750, the obstacle detection system 156 may re-classify the non-ground point as a ground point. These ground points may now be used to populate the height map again, to re-estimate a terrain map 403, for example in block 320 of process 300.

At block 745, the obstacle detection system 156 may leave those points as non-ground points.

The order of the various blocks in process 300, 500, 600 and 700 can occur in any order. Additionally or alternatively, one or more blocks may be skipped, one or more blocks may be performed in parallel, and/or one or more blocks may be combined, and/or one or more blocks may be performed in any number of sub-blocks.

The computational system 800, shown in FIG. 10 can be used to perform any of the examples disclosed in this document. For example, computational system 800 can be used to execute process 300, 500, 600 and 700. As another example, computational system 800 can perform any calculation, identification and/or determination described here. Computational system 800 includes hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computational system 800 may further include (and/or be in communication with) one or more storage devices 825, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 800 might also include a communications subsystem 830, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 830 may permit data to be exchanged with a network (such as the network described below, to name one example), and/or any other devices described in this document. The computational system 800, for example, may include a working memory 835, which can include a RAM or ROM device, as described above.

The computational system 800 also can include software elements, shown as being currently located within the working memory 835, including an operating system 840 and/or other code, such as one or more application programs 845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 825 described above.

The storage medium, for example, might be incorporated within the computational system 800 or in communication with the computational system 800. The storage medium might be separate from a computational system 800 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Although term “autonomous work vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

1. An autonomous work vehicle comprising:
a Lidar sensor;
a vehicle control unit in communication with the Lidar sensor, the vehicle control unit configured to:
receive Lidar data comprising a point cloud including a plurality of points from the Lidar sensor;
classify points from the point cloud into ground points and non-ground points, wherein the ground points are considered to represent the ground, and wherein the non-ground points are considered to represent non-ground objects;
estimate a height map based on the classified ground points;
determine object features based on the non-ground points, the object features including at least one of a size of an object, a height of the object, a lowest point of the object, and a slope of a terrain under an object based on the classified ground and non-ground points and the estimated height map;
classify the object as a hazard or non-hazard based on the determined object features;
wherein the vehicle control unit is configured to send a limit signal to limit movement of the autonomous work vehicle if the object is classified as a hazard;
wherein the vehicle control unit is configured to ignore the object if the object is classified as a non-hazard.

2. The autonomous work vehicle according to claim 1, wherein the vehicle control unit is configured to:
classify the object as a non-hazard if the size of the object is below a threshold size and the lowest point of the object is above a threshold distance in a vertical direction from the ground based on the height map;
classify the object as a hazard if the size of the object is at or above the threshold size and/or the lowest point of the object is below the threshold distance in a vertical direction from the height map.

3. (canceled)

4. (canceled)

5. The autonomous work vehicle according to claim 1, wherein the vehicle control unit is configured to classify points as ground or non-ground by:
choosing a plurality of query points and performing neighborhood queries on a point neighborhood for each query point, the point neighborhood being defined by a plurality of points within a query radius of the respective query point;
determining geometric features for each point neighborhood including at least one of eigenvalues of a structure tensor matrix, omnivariance, surface variation, sphericity, height difference, smoothness and/or orientation;
classifying all of the points within the point neighborhood as non-ground or ground based on the geometric features.

6. The autonomous work vehicle according to claim 1, wherein the vehicle control unit is configured to select query points based on voxel-based down-sampling, such that a neighborhood query is performed on one point within each voxel, and wherein the query radius for the neighborhood query is larger than a value that scales with the voxel size.

7. The autonomous work vehicle according to claim 1, wherein the vehicle control unit is configured to classify point neighborhoods as non-ground or ground based on the geometric features by comparing the geometric feature against a respective threshold or using a learning model.

8. The autonomous work vehicle according to claim 7, wherein the vehicle control unit is configured to give precedence to non-ground classification when the plurality of points are classified within different point neighborhoods as both ground and non-ground.

9. The autonomous work vehicle according to claim 1, wherein the vehicle control unit is configured to cluster non-ground points into object clusters representing an object, and to compute cluster features for each object cluster including:
number of points in the object cluster;
height of the lowest point of the object cluster above the ground based on the height map;
height difference between the highest point and the lowest point of the object cluster; and/or
average last return ratio of the points in the object cluster.

10. The autonomous work vehicle according to claim 1, wherein the vehicle control unit is configured to compare the classified non-ground points against the height map to identify a distance from the ground, and if the distance from the ground is below a ground threshold, to reclassify the respective non-ground points as ground points.

11. The autonomous work vehicle according to claim 1, wherein the vehicle control unit is configured to filter out points of the plurality of points in the point cloud before classifying the points, wherein the filtering includes:
filtering for a minimum intensity by excluding points below a minimum intensity;
lonely point filtering by excluding points which are far away from other points; and/or
area checks including excluding points known to be returned from the autonomous work vehicle.

12. (canceled)

13. (canceled)

14. The autonomous work vehicle according to claim 1, further comprising:
a steering control system; and
a braking control system;
wherein the vehicle control unit is configured to operate the autonomous work vehicle along a path using the steering control system and the barking control system while limiting movement of the autonomous work vehicle if the object is classified as a hazard and ignoring the object if the object is classified as a non-hazard.

15. A method comprising:
receiving Lidar data comprising a point cloud including a plurality of points from a Lidar sensor on an autonomous work vehicle;
classifying points from the point cloud into ground points and non-ground points, wherein the ground points are considered to represent the ground, and wherein the non-ground points are considered to represent non-ground objects;
estimating a height map based on the classified ground points;
determining object features based on the non-ground points, the object features including at least one of a size of an object, a height of an object, a lowest point of the object, and a slope of a terrain under an object based on the classified non-ground points and the estimated heightmap;
classifying the object as a hazard or non-hazard based on the determined object features;
if the object is classified as a hazard, then send a limit signal to limit the movement of the autonomous work vehicle;
if the object is classified as a non-hazard, then ignore the object.

16. The method according to claim 15, wherein if the size of the object is below a threshold size and the lowest point of the object is above a threshold distance in a vertical direction from the ground based on the height map, then classify the object as a non-hazard;
if the size of the object is at or above the threshold size and/or the lowest point of the object is below the threshold distance in a vertical direction from the height map, then classify the object as a hazard.

17. The method according to claim 15, wherein limiting movement of the autonomous work vehicle comprises preventing the autonomous work vehicle from entering an exclusion zone within a threshold gap from the object.

18. The method according to claim 17, wherein populating the height map comprises using the lowest identified ground point for each cell of the map.

19. The method according to claim 17, wherein the classified non-ground points are compared against the height map to identify a distance from the ground, and if the distance from the ground is below a ground threshold, then the respective non-ground points are reclassified as ground points.

20. (canceled)

21. The method according to claim 17, wherein if the size of the object is below the threshold size and the lowest point of the object is below the threshold distance from the estimated ground profile, then the threshold gap is smaller than 1.1 m, such as 0.3 m.

22. (canceled)

23. (canceled)

24. (canceled)

25. (canceled)

26. (canceled)

27. (canceled)

28. The method according to claim 15, wherein non-ground points are clustered into object clusters representing an object, and cluster features are computed for each object cluster including:
number of points in the object cluster;
height of the lowest point of the object cluster above the ground based on the height map;
height difference between the highest point and the lowest point of the object cluster; and/or
average last return ratio of the points in the object cluster.

29. The method according to claim 15, wherein points of the point cloud are filtered before classifying them, wherein the filtering includes:
filtering for a minimum intensity by excluding points below a minimum intensity;
lonely point filtering by excluding points which are far away from other points; and/or
area checks including excluding points known to be returned from the autonomous work vehicle.

30. The method according to claim 15, wherein the object features are determined by, and relate to:
modelling a bounding sphere and/or vertically oriented cylinder around an object cluster, the object cluster comprising a cluster of non-ground points representing an object.

31. (canceled)

32. (canceled)

33. (canceled)

34. The method according to claim 15, further comprising operating the autonomous work vehicle along a path using the steering control system and the barking control system while limiting movement of the autonomous work vehicle if the object is classified as a hazard and ignoring the object if the object is classified as a non-hazard.
